(19) United States
(12) Patent Application Publication
(10) Pub. No.: US 2006/0090201 A1
(43) Pub. Date: Apr. 27, 2006

(54) Computer system and control method thereof

(75) Inventor: Jong-uk Ha, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/252,813

(22) Filed: Oct. 19, 2005

(30) Foreign Application Priority Data
Oct. 26, 2004 (KR) 2004-0085954

(51) Int. Cl. G06K 9/00

(52) U.S. Cl. 726/7

(57) ABSTRACT

A computer system with a display is provided to effectively prevent an unwanted user from accessing the computer system. The computer system has a password storage device to store a plurality of password request sentences and a plurality of passwords corresponding to the respective password request sentences, and a controller to randomly select and display at least one of the plurality of password request sentences on the display and to perform a system booting procedure when an input password is identical to the password corresponding to the displayed password request sentence.

### PRIORITY

This application claims the benefit under 35 U.S.C. §119(a) of Korean Patent Application No. 2004-0085954, filed on Oct. 26, 2004, in the Korean Intellectual Property Office, the entire contents of which are incorporated herein by reference.

### BACKGROUND OF THE INVENTION

1. Field of the Invention

The present invention relates to a computer system, and more particularly, to a computer system and a control method thereof, in which a plurality of password request sentences and a plurality of passwords are provided to effectively prevent an unwanted user from accessing the computer system.

2. Description of the Related Art

Generally, a computer system comprises a display, and a basic input/output system (BIOS) read only memory (ROM) to store a BIOS. Here, the BIOS determines whether computer components are normally enabled when a computer is turned on, and performs a power_on_self_test (POST) procedure.

Such a computer system has various security functions to prevent information stored therein from being accessed by unauthorized users. For example, a security function that has recently been widely used employs a method of requiring a user who wants to access the computer system to input a password.

According to the foregoing method, when the computer system is turned on and receives power, the BIOS performs the POST procedure. While the POST procedure is performed, a password input window is displayed on the display, thereby requiring a user to input the password. Then, a user inputs a password through an input unit such as a keyboard, and a system booting procedure is normally completed only when the inputted password is identical to the password previously stored in the computer system.

However, such a conventional security function requires only one password to be inputted while the system booting is performed.

Therefore, in the conventional computer system, when the password becomes known to an unwanted user, the unwanted user can readily access the computer system by inputting the password. Thus, it is difficult to maintain security.

### SUMMARY OF THE INVENTION

Accordingly, it is an object of the present invention to provide a computer system and a control method thereof in which a plurality of password request sentences and a plurality of passwords are provided to effectively prevent an unwanted user from accessing the computer system.

The foregoing and/or other objects of the present invention are achieved by providing a computer system with a display, comprising a password storage device to store a plurality of password request sentences and a plurality of passwords corresponding to the respective password request sentences; and a controller to randomly select and display at least one of the plurality of password request sentences on the display, and normally perform a system booting procedure when an input password is identical to the password corresponding to the displayed password request sentence.

According to an aspect of the present invention, the plurality of password request sentences stored in the password storage device are modified and inputted by a user.

According to an aspect of the present invention, the controller comprises a BIOS stored in a BIOS ROM.

According to an aspect of the present invention, the computer system further comprises an input unit allowing a user to input a key. The BIOS comprises a BIOS setup menu having a password request sentence modification selection/input item to allow a user to modify the password request sentence. The computer system stores the password request sentence modified by a user through the input unit and the password corresponding to the modified password request sentence in the password storage device when the password request sentence modification selection/input item is selected from the BIOS setup menu by the user via the input unit.

According to an aspect of the present invention, the BIOS displays a password request sentence modification/input window allowing a user to modify the password request sentence on the display

According to an aspect of the present invention, the BIOS stores the password request sentence modified on the password request sentence modification/input window by a user via the input unit and the password corresponding to the modified password request sentence in the password storage device when the password request sentence modification/input item to modify the password request sentence is selected by a user via the input unit.

According to an aspect of the present invention, the BIOS randomly selects and displays one of the plurality of password request sentences on the display again when the input password is determined to not be identical to the password corresponding to the displayed password request sentence on the basis of information stored in the password storage device.

According to an aspect of the present invention, the BIOS stops the system booting procedure when the input password is determined to not be identical to the password corresponding to the displayed password request sentence a predetermined number of times.

The foregoing and/or other aspects of the present invention are achieved by a method of controlling a computer system with a display, the method comprising the steps of: storing a plurality of password request sentences and a plurality of passwords corresponding to the respective password request sentences; randomly selecting and displaying at least one of the plurality of password request sentences on the display; determining whether an input password is identical to the password corresponding to the displayed password request sentence; and normally performing a system booting procedure when the input password is identical to the password corresponding to the displayed password request sentence.

According to an aspect of the present invention, the method further comprises the steps of: randomly selecting and displaying one of the plurality of password request sentences on the display again when the input password is not identical to the password corresponding to the displayed password request sentence; and stopping the system booting procedure when the input password is not identical to the password corresponding to the displayed password request sentence a predetermined number of times.

According to an aspect of the present invention, the method further comprises the steps of: displaying a menu comprising a password request sentence modification/input item to modify the password request sentence; and storing a password request sentence modified by a user and a password inputted corresponding to the modified password request sentence in response to selection of the password request sentence modification/input item by a user.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a block diagram of a computer system according to an embodiment of the present invention;

FIG. 2 is a flowchart of a sequence of operating of the computer system according to an embodiment of the present invention;

FIG. 3 is a flowchart of a sequence of operations for modifying a password request sentence in the computer system according to an embodiment of the present invention;

FIG. 4 illustrates a password input window displayed in the computer system according to an embodiment of the present invention; and

FIG. 5 illustrates a password request sentence modification/input window displayed in the computer system according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

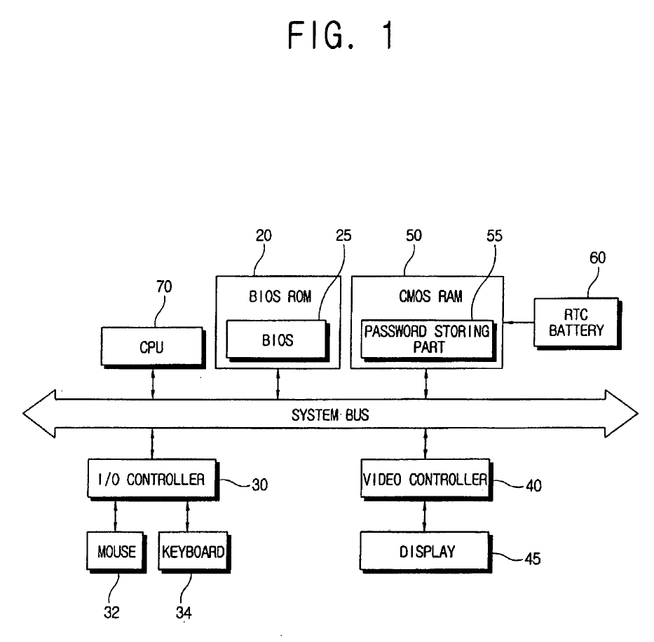

FIG. 1 is a control block diagram of a computer system according to an embodiment of the present invention. As shown therein, a computer system according to an embodiment of the present invention comprises: a system bus used as a transmission path through which data is transferred between various computer components; a BIOS ROM 20 to store a BIOS 25; an input/output (I/O) controller 30 to control an input signal inputted from a mouse 32 and/or a keyboard 34 used as an input unit; and a video controller 40 to control a display 45 used as an output unit. Further, the computer system according to an embodiment of the present invention comprises a complementary metal oxide semiconductor (CMOS) random access memory (RAM) 50 receiving power from a real time clock (RTC) battery 60 and storing system information. Here, the CMOS RAM 50 comprises a password storing part 55 to store a plurality of password request sentences and a plurality of passwords corresponding to the password request sentences.

The CMOS RAM 50 receives the power from the RTC battery 60 and the like, stores various data such as system setting data, that must be conserved even if external alternating current (AC) power is interrupted. Further, the CMOS RAM 50 comprises the password storing part 55 to store the plurality of password request sentences and the plurality of passwords inputted to be set by a user in correspondence with the respective password request sentences.

The BIOS ROM 20 comprises a BIOS 25 to check whether various computer components are normally enabled when a computer is turned on, and to perform a POST procedure for operating the computer system.

While the POST procedure is performed to check a state of the computer, the BIOS 25 randomly selects one of the plurality of password request sentences on the basis of information stored in the password storing part 55, thereby displaying the selected password request sentence on the display 45. That is, the BIOS 25 creates a random digit and displays the password request sentence corresponding to the random digit among the plurality of password request sentences on the display 45. Thereafter, the BIOS 25 normally performs a system booting procedure when an input password inputted by a user is matched with the displayed password request sentence, that is to say, when the input password is consistent with the corresponding password of the password request sentence.

Thus, in the computer system according to an exemplary embodiment of the present invention, even though one of the plurality of passwords becomes known to an unwanted user, the system booting procedure is not normally completed unless the input password is matched with the password request sentence randomly selected and displayed among the plurality of password request sentences while the system booting procedure is performed, thereby effectively preventing an unwanted user from accessing the computer system.

When an input password is not matched with the password request sentence randomly selected and displayed on the basis of the information stored in the password storing part 55, the BIOS 25 preferably creates a new random digit again and displays another password request sentence that corresponds to the new random digit on the display 45. Further, when the password request sentences are randomly selected and displayed a predetermined number or more times because an input password is not matched with the password request sentence, the BIOS 25 stops the system booting procedure.

Thus, even if a user does not remember all passwords corresponding to the plurality of the password request sentences, a user can make the computer system normally perform the system booting procedure. Here, a user can set the predetermined number of times.

Meanwhile, the plurality of password request sentences stored in the password storing part 55 can be increased, deleted, or modified by a user.

According to an exemplary embodiment of the present invention, a user can modify the password request sentence, and a password request sentence modification/input item may be added in a BIOS setup menu.

Thus, when the password request sentence modification/input item is selected by a user in the BIOS setup menu through the input unit, the BIOS 25 displays a password request sentence modification/input window on the display 45 and stores the password request sentence modified via the password request sentence modification/input window and the password inputted corresponding to the modified password request sentence in the password storing part 55.

According to another exemplary embodiment of the present invention, a user can modify the password request sentence, and the password request sentence is randomly selected for the security function and displayed on the display 45 while the POST procedure is performed. At the same time, the password request sentence modification/input window is additionally displayed for modifying the password request sentence.

Thus, when the password request sentence modification/input item is selected via the input unit, the BIOS 25 displays a password request sentence modification/input window on the display 45 and stores the password request sentence modified through the password request sentence modification/input window and the password inputted corresponding to the modified password request sentence in the password storing part 55.

Therefore, in the computer system according to an exemplary embodiment of the present invention, a user can directly modify/set the suitable password request sentences for remembering the plurality of passwords he/she wants.

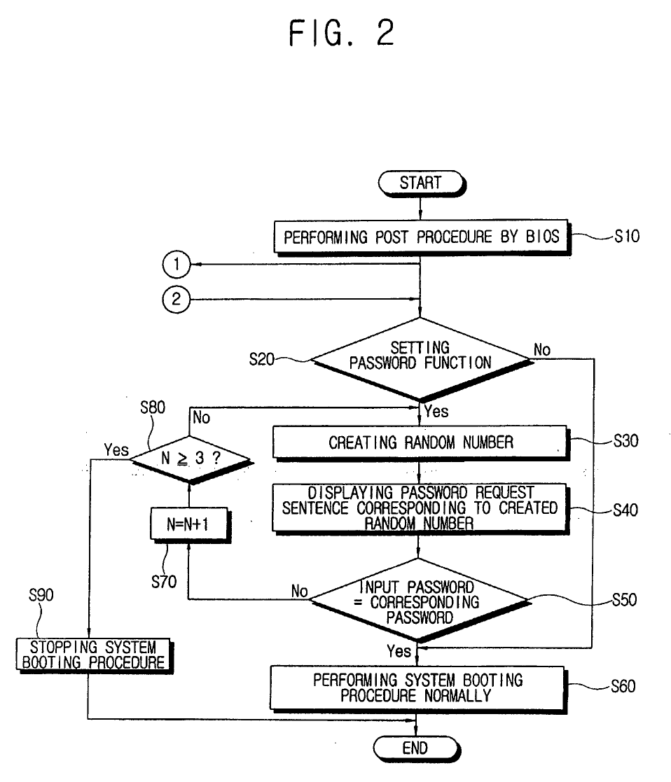

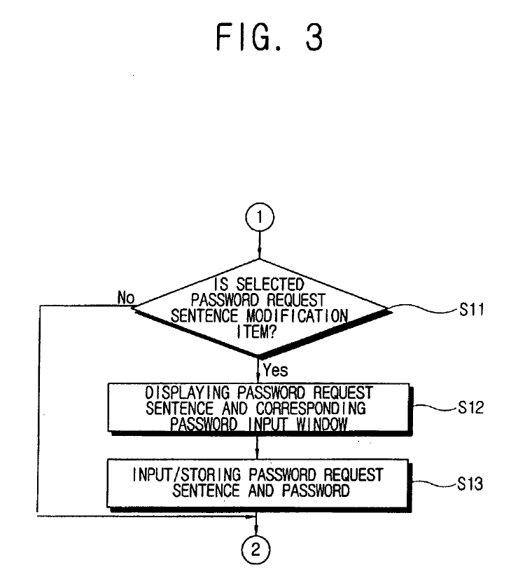

With this configuration, a control flow of the computer system according to an exemplary embodiment of the present invention will be described with reference to FIGS. 2 and 3.

First, when the computer is turned on and receives the power, at operation S10, the BIOS 25 is controlled by a central processing unit (CPU) 70 to start the POST procedure. While the POST procedure is performed, at operation S20, the BIOS 25 determines whether a password function is set. In a case that the password function is set, at operation S30, the BIOS 25 creates the random digit among digits based on the number of password request sentences set/stored in the password storing part 55. At operation S40, the BIOS 25 displays the password request sentence corresponding to the created random digit on the display 45. At this time, a user inputs the password for the displayed password request sentence. At operation S50, the BIOS 25 determines whether an input password is matched with the displayed password request sentence. In a case that the input password is matched with the displayed password request sentence, at operation S60, the BIOS 25 normally performs the system booting procedure.

Here, in the operation S10, the number ‘N’ of password input times is initialized to ‘0’. As a result of determination in the operation S50, when an input password is not matched with the displayed password request sentence, the BIOS 25 increases ‘N’ by ‘1’ at operation S70, and determines whether ‘N’ is equal to or more than ‘3’ at operation S80. In a case that ‘N’ is less than ‘3’, the BIOS 25 repeats the operation S30 and the operations S40 and S50. Thus, the BIOS 25 increases ‘N’ by ‘1’ and repeats the operation S30 through S50 when the input password is not matched with the displayed password request sentence, and stops the system booting procedure at operations S90 when ‘N’ is equal to or more than ‘3’ in the operation S80, i.e., when the operation S30 through S50 are repeated by a predetermined number of times. It is to be understood that the predetermined number can be essentially any number (e.g., integer) and that ‘3’ is used herein for illustrative purpose only.

FIG. 3 is a flowchart illustrating operations for modifying a password request sentence in the computer system according to an exemplary embodiment of the present invention. Here, the password request sentence will be modified by way of example through the BIOS setup menu while the POST procedure is performed. Accordingly, as a specific key input occurs by a user in an operation \textcircled{1} of FIG. 2, and the BIOS setup menu is implemented while the POST procedure is performed at operation S11, the BIOS 25 determines whether the password request sentence modification, input item is selected. When the password request sentence modification/input item is selected, at operation S12, the BIOS 25 displays the password request sentence modification/input window on the display 45. At operation S13, the BIOS 25 stores the password request sentence modified through the displayed password request sentence modification/input window, and the password inputted corresponding to the modified password request sentence in the password storing part 55. Then, an operation \textcircled{2} of FIG. 2 is implemented.

In the foregoing description, the password request sentence is modified while the POST procedure is performed. Alternatively, the password request sentence may be modified by a user through a predetermined menu after the system booting procedure is normally completed and the computer normally operates.

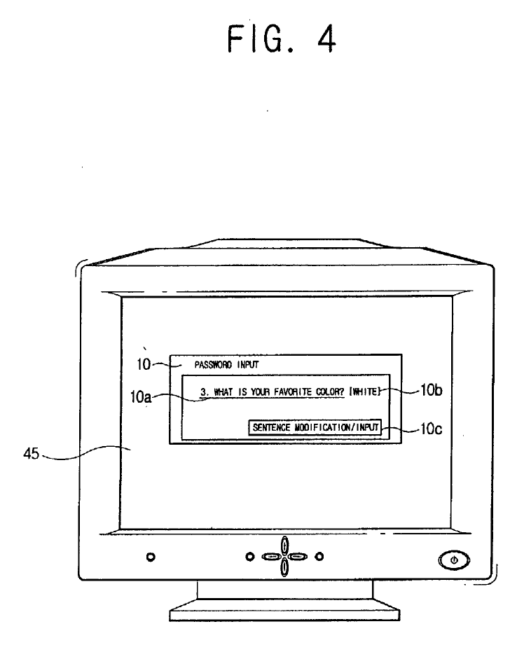

FIG. 4 illustrates an exemplary password input window displayed on the display 45 through the foregoing operations. As shown therein, a password input window 10 displays a password request sentence 10a selected from among the plurality of password request sentences stored in the password storing part 55. In a case that a password 10b for the password request sentence 10a is inputted by a user and the input password 10b is matched with the password request sentence 10a, the password input window 10 disappears and then the system booting procedure is implemented. Alternatively, the password input window 10 may display the plurality of password request sentences.

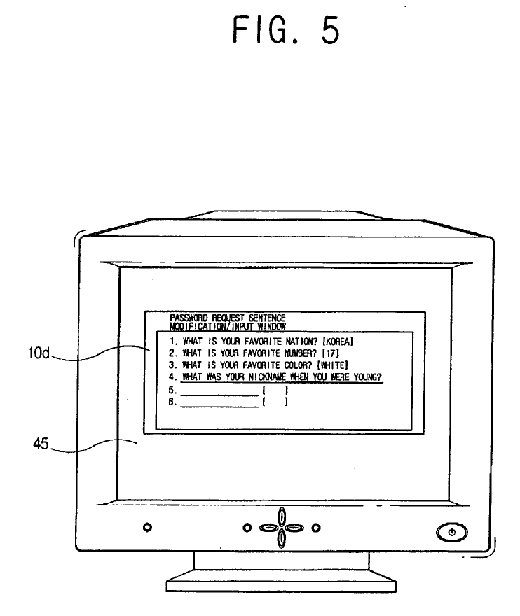

Additionally, the password input window 10 can display the password request sentence and, at the same time, display a password request sentence modification/input item 10c for allowing a user to modify the password request sentence. When a user selects the password request sentence modification/input item 10c through the input unit, the BIOS 25 displays a window as shown in FIG. 5.

In FIG. 5, a password request sentence modification/input window 10d displays the password request sentences and the passwords corresponding to the password request sentences stored in the password storing part 55. As shown therein, a user can make and set the password request sentence via an input unit (e.g., keyboard 34 and/or mouse 32). For example, a user can set “What was your nickname when you were young?” as the password request sentence to an item No. 4, and then set an answer corresponding thereto as the password, wherein the question and the answer are stored.

Thus, in the computer system according to an exemplary embodiment of the present invention, the password request sentence randomly selected among the plurality of password request sentences is displayed while the system booting procedure is performed. The system booting procedure is not normally completed unless an input password is matched with the displayed password request sentence, so that an unwanted user is effectively prevented from accessing the computer system even though one of the plurality of passwords becomes known to the unwanted user.

As described above, the present invention provides a computer system and a control method thereof, in which a plurality of password request sentences and a plurality of passwords are provided to effectively prevent an unwanted user from accessing the computer system.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A computer system with a display, comprising:
a password storage device to store information comprising a plurality of password request sentences and a plurality of passwords corresponding to the respective password request sentences; and
a controller to randomly select and display at least one of the plurality of password request sentences on the display, and perform a system booting procedure when an input password is identical to the password corresponding to the displayed password request sentence.

2. The computer system according to claim 1, wherein the plurality of password request sentences stored in the password storage device are modified and inputted by a user.

3. The computer system according to claim 2, wherein the controller comprises a basis input/output system (BIOS) stored in a BIOS ROM.

4. The computer system according to claim 3, further comprising an input unit allowing a user to input a key;
wherein the BIOS comprises a BIOS setup menu having a password request sentence modification selection/input item to modify the password request sentence, and stores the password request sentence modified by a user through the input unit and the password corresponding to the modified password request sentence in the password storage device when the password request sentence modification selection/input item is selected from the BIOS setup menu by the user via the input unit.

5. The computer system according to claim 4, wherein the BIOS displays a password request sentence modification/input window allowing a user to modify the password request sentence on the display

6. The computer system according to claim 5,
wherein the BIOS stores the password request sentence modified on the password request sentence modification/input window by a user via the input unit and the password corresponding to the modified password request sentence in the password storage device when a password request sentence modification/input item to modify the password request sentence is selected by a user via the input unit.

7. The computer system according to claim 1, wherein the computer system comprises a basic input/output system (BIOS) and the BIOS randomly selects and displays one of the plurality of password request sentences on the display again when the input password is determined to not be identical to the password corresponding to the displayed password request sentence based on a comparison of the input password with the information stored in the password storage device.

8. The computer system according to claim 7, wherein the BIOS stops the system booting procedure when the input password is determined to not be identical to the password corresponding to the displayed password request sentence a predetermined number of times.

9. The computer system according to claim 2, wherein the computer system comprises a basic input/output system (BIOS) and the BIOS randomly selects and displays one of the plurality of password request sentences on the display again when the input password is determined to not be identical to the password corresponding to the displayed password request sentence based on a comparison of the input password with the information stored in the password storage device.

10. The computer system according to claim 9, wherein the BIOS stops the system booting procedure when the input password is determined to not be identical to the password corresponding to the displayed password request sentence a predetermined number of times.

11. The computer system according to claim 3, wherein the BIOS randomly selects and displays one of the plurality of password request sentences on the display again when that the input password is determined to not be identical to the password corresponding to the displayed password request sentence based on a comparison of the input password with the information stored in the password storage device.

12. The computer system according to claim 11, wherein the BIOS stops the system booting procedure when the input password is determined to not be identical to the password corresponding to the displayed password request sentence a predetermined number of times.

13. The computer system according to claim 4, wherein the BIOS randomly selects and displays one of the plurality of password request sentences on the display again when the input password is determined to not be identical to the password corresponding to the displayed password request sentence based on a comparison of the input password with the information stored in the password storage device.

14. The computer system according to claim 13, wherein the BIOS stops the system booting procedure when the input password is determined to not be identical to the password corresponding to the displayed password request sentence a predetermined number of times.

15. The computer system according to claim 5, wherein the BIOS randomly selects and displays one of the plurality of password request sentences on the display again when the input password is determined to not be identical to the password corresponding to the displayed password request sentence based on a comparison of the input password with the information stored in the password storage device.

16. The computer system according to claim 15, wherein the BIOS stops the system booting procedure when the input password is determined to not be identical to the password corresponding to the displayed password request sentence a predetermined number of times.

17. The computer system according to claim 6, wherein the BIOS randomly selects and displays one of the plurality of password request sentences on the display again when the input password is determined to not be identical to the password corresponding to the displayed password request sentence based on a comparison of the input password with the information stored in the password storage device.

18. The computer system according to claim 17, wherein the BIOS stops the system booting procedure when the input password is determined to not be identical to the password corresponding to the displayed password request sentence is a predetermined number of times.

19. A method of controlling a computer system with a display, the method comprising:
storing a plurality of password request sentences and a plurality of passwords corresponding to the respective password request sentences;
randomly selecting and displaying at least one of the plurality of password request sentences on the display;
determining whether an input password is identical to the password corresponding to the displayed password request sentence; and
performing a system booting procedure when the input password is identical to the password corresponding to the displayed password request sentence.

20. The method according to claim 19, further comprising the steps of:
randomly selecting and displaying one of the plurality of password request sentences on the display again when the input password is determined to not be identical to the password corresponding to the displayed password request sentence; and
stopping the system booting procedure when the input password is determined to not be identical to the password corresponding to the displayed password request sentence a predetermined number of times.

21. The method according to claim 19, further comprising:
displaying a menu comprising a password request sentence modification/input item to modify the password request sentence; and
storing a password request sentence modified by a user and a password inputted corresponding to the modified password request sentence in response to selection of the password request sentence modification/input item by a user.

22. The method according to claim 20, further comprising:
displaying a menu comprising a password request sentence modification/input item to modify the password request sentence; and
storing a password request sentence modified by a user and a password inputted corresponding to the modified password request sentence in response to selection of the password request sentence modification/input item by a user.

23. A method of controlling a computer system with a display, the method comprising the steps of:
storing a plurality of password request sentences and a plurality of passwords corresponding to the respective password request sentences;
performing a power-on-self-test or POST procedure to operate the computer system;
randomly selecting and displaying one of the plurality of password request sentences;
performing a system booting procedure when an inputted password is determined to be identical to the password corresponding to the displayed password request sentence; and
stopping the system booting procedure when the inputted password is determined to not be identical to the password corresponding to the displayed password request sentence.

24. The method according to claim 23, wherein the randomly selecting and displaying step comprises the steps of:
creating a random digit via a BIOS; and
retrieving a password request sentence corresponding the random digit.

25. The method according to claim 23, wherein the system booting procedure is not completed unless the inputted password is matched with the password request sentence that is randomly selected and displayed while the system booting procedure is performed.

26. The method according to claim 23, wherein password request sentence is modified by a user through a predetermined menu after the system booting procedure is normally completed and the computer normally operates.
